(19) United States
(12) Patent Application Publication
(10) Pub. No.: US 2025/0179838 A1
(43) Pub. Date: Jun. 5, 2025

(54) INTERLOCKING ANTI-TIPPING CABINET

(71) Applicant: HSIN TIEN SHUN CO., LTD., Kaohsiung City (TW)

(72) Inventor: Victor LEE, Kaohsiung City (TW)

(73) Assignee: HSIN TIEN SHUN CO., LTD., Kaohsiung City (TW)

(21) Appl. No.: 18/525,766

(22) Filed: Nov. 30, 2023

(51) Int. Cl. E05B 65/464

(52) U.S. Cl. CPC E05B 65/464

(57) ABSTRACT

An interlocking anti-tipping cabinet comprises a cabinet body, multiple drawers, which are mounted inside the cabinet body, and a linkage mechanism. An assembling groove vertically elongates and is formed inside the cabinet body. Each of the multiple drawers has a guiding rail and a blocking chunk, which protrude and face the assembling groove. The linkage mechanism is up-and-down moveable, is mounted in the assembling groove, and has multiple wheels respectively corresponding to the multiple drawers. By structural designs of the guiding rail and the blocking chunk of each of the multiple drawers and the linkage mechanism, the interlocking anti-tipping cabinet locks other drawers when one drawer is pulled open. At the same time, an overall structure of the cabinet is simplified, hence effectively decreasing the assembling difficulty and costs of materials and processing.

### BACKGROUND OF THE INVENTION

### 1. Field of the Invention

The present invention relates to an interlocking anti-tipping cabinet having multiple drawers, and when one of the drawers is pulled open, the other drawers are locked simultaneously to prevent the cabinet from tipping over.

### 2. Description of Related Art

A cabinet is furniture widely used for storing objects. Usually, the cabinet comprises a cabinet body and multiple drawers. The multiple drawers are mounted at the cabinet body and can be pulled open from or pushed back into the cabinet body. By pulling open the drawers, a user can store and categorize objects.

However, when the drawers of the cabinet are pulled open, a gravity center of the cabinet is affected by the pulled-open drawer and the gravity center's position is changed. As more of the drawers are pulled open, the position of the gravity center of the cabinet is shifted further away from the cabinet body, causing the cabinet prone to tipping over due to external forces.

Therefore, to avoid multiple drawers of a cabinet being pulled open simultaneously and displacing the cabinet's gravity center significantly, a sliding rail lock lever type drawer anti-tipping safety device with Publication Number TWM623058U is provided. By multiple locking rods and a returning spring, which is at a bottom of one of the locking rods, cooperating with a stop part, drawers of a cabinet, which has the sliding rail lock lever type drawer anti-tipping safety device, are limited in position. So, when any one of the drawers is pulled open, the rest of the drawers is blocked and restrained, hence to prevent the cabinet from tipping over.

However, the sliding rail lock lever type drawer anti-tipping safety device has numerous components and is complicated in structure, thus taking more time in assembling and having higher costs of materials and processing. Therefore, to simplify structure and have lockable drawers to prevent a cabinet from tipping over is the purpose of the present invention.

### SUMMARY OF THE INVENTION

The objective of the present invention is to provide an interlocking anti-tipping cabinet to resolve the drawback that a drawer locking mechanism nowadays is complicated in structure, and thus has higher costs of assembling, materials, and processing.

The interlocking anti-tipping cabinet comprises a cabinet body, multiple drawers and a linkage mechanism. The cabinet body has a loading portion and an assembling groove. The loading portion is formed inside the cabinet body and comprises multiple loading spaces, which are arranged vertically. Each of the multiple loading spaces has an opening oriented forward. The assembling groove elongates vertically and is disposed at an inner-side wall of the cabinet body and beside the openings of the multiple loading spaces. The assembling groove communicates with the multiple loading spaces. The multiple drawers are respectively mounted at the multiple loading spaces of the cabinet body. Each one of the multiple drawers has multiple extendable slides elongating horizontally and is mounted at the corresponding loading space of the cabinet body through the multiple extendable slides. Each one of the multiple drawers has a side surface, which is oriented toward the assembling groove, a guiding rail, a blocking chunk, an ascending passage, a locking passage and an initial area. The guiding rail and the blocking chunk both protrude from and are formed at the side surface of said drawer. The guiding rail has a wedging section, which has a guiding slope having a height progressively increasing backward, and a horizontal section, which is connected to a back end of the wedging section and has a positioning plane elongating horizontally. The blocking chunk is disposed over the wedging section of the guiding rail. The ascending passage is formed between the wedging section of the guiding rail and the blocking chunk. The locking passage is formed on top of the wedging section and at a front side of the blocking chunk, and elongates vertically. The initial area is formed at an intersection of the ascending passage and the locking passage. The linkage mechanism comprises a main shaft and multiple wheels. The main shaft is mounted in the assembling groove of the cabinet body and is moveable up and down. The multiple wheels are mounted at a side, oriented toward the multiple drawers, of the main shaft, and are spaced apart from each other. Each one of the multiple wheels corresponds to one of the multiple drawers, is disposed at the initial area of the corresponding drawer, and abuts the guiding slope of the wedging section of the guiding rail of the corresponding drawer.

By the simple guiding rail and the blocking chunk of each of the multiple drawers forming the ascending passage and the locking passage, and by the multiple drawers cooperating with the linkage mechanism, when any one of the multiple drawers of the interlocking anti-tipping cabinet is pulled open, the corresponding wheel is moved along the ascending passage and drives the main shaft of the linkage mechanism. Other wheels are driven by the main shaft and are moved along the locking passages of the corresponding drawers to the front side of the blocking chunk, so that other drawers are respectively blocked by the corresponding wheels and cannot be pulled open. Thus, the cabinet is prevented from tipping over, which is due to multiple pulled-open drawers shifting the cabinet's gravity center.

Therefore, the interlocking anti-tipping cabinet possesses the function of locking the rest of the drawers when one drawer is pulled open and simplifies the overall structure, effectively decreasing the assembling difficulty and costs of materials and processing.

### BRIEF DESCRIPTION OF THE DRAWINGS

FIG. 1 is a perspective view of a first embodiment of an interlocking anti-tipping cabinet in accordance with the present invention with a drawer pulled open;

FIG. 2 is a partially-sectional view of FIG. 1;

FIG. 3 is a partially-enlarged view of FIG. 2 from another angle;

FIG. 4 is a side sectional view of the first embodiment of the interlocking anti-tipping cabinet with the drawer pulled open;

FIG. 5 is a partially enlarged view of FIG. 4;

FIG. 6 is a front sectional view of the first embodiment of the interlocking anti-tipping cabinet with the drawer pulled open;

FIG. 7 is a side sectional view of the first embodiment of the interlocking anti-tipping cabinet with the drawer closed;

FIG. 8 is a perspective view of a second embodiment of the interlocking anti-tipping cabinet with the drawer pulled open;

FIG. 9 is a partially-sectional view of FIG. 8; and

FIG. 10 is a partially-sectional front view of the second embodiment of the interlocking anti-tipping cabinet with the drawer pulled open.

### DETAILED DESCRIPTION OF THE PREFERRED EMBODIMENT

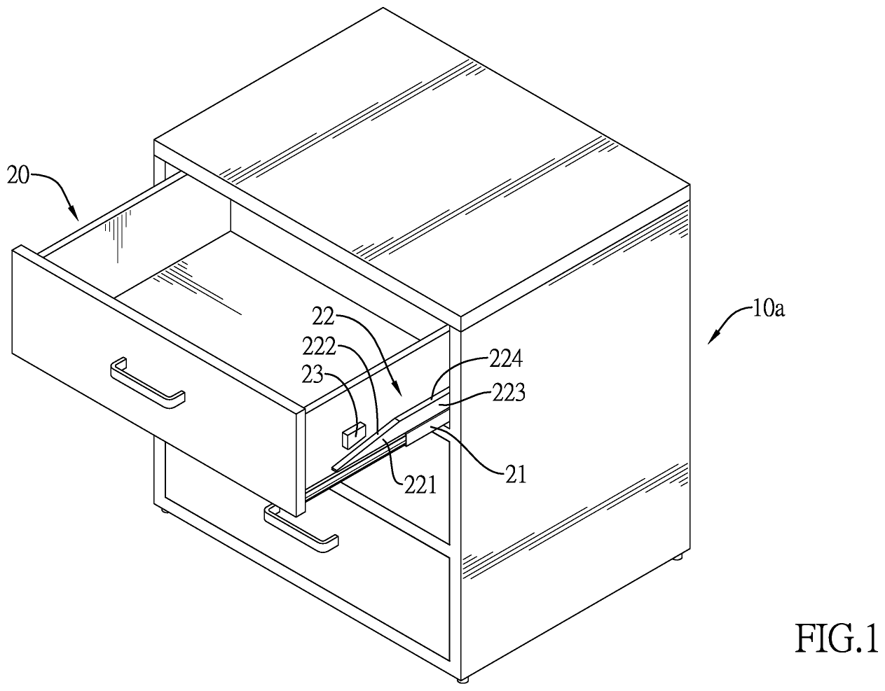

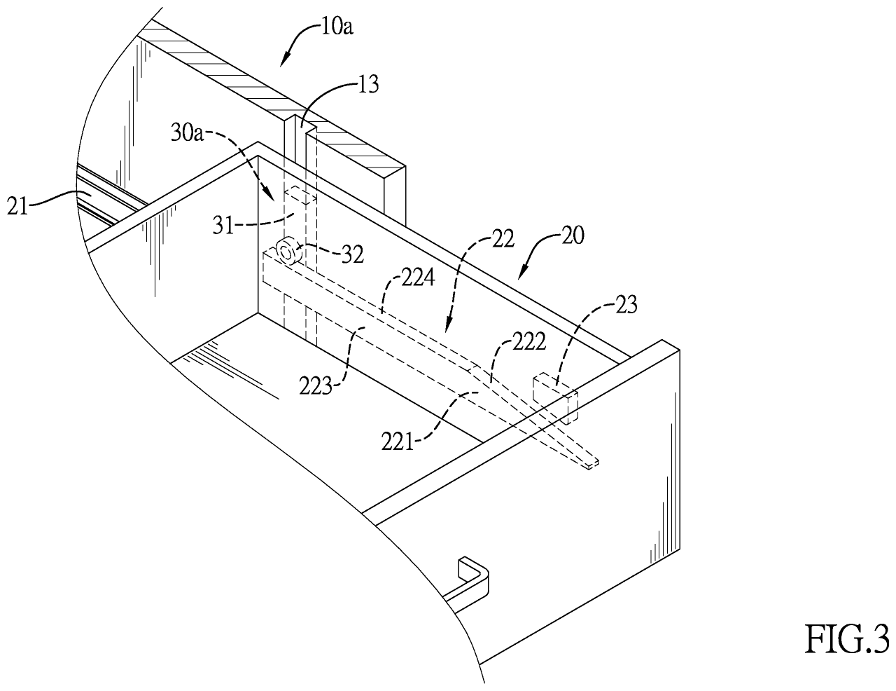

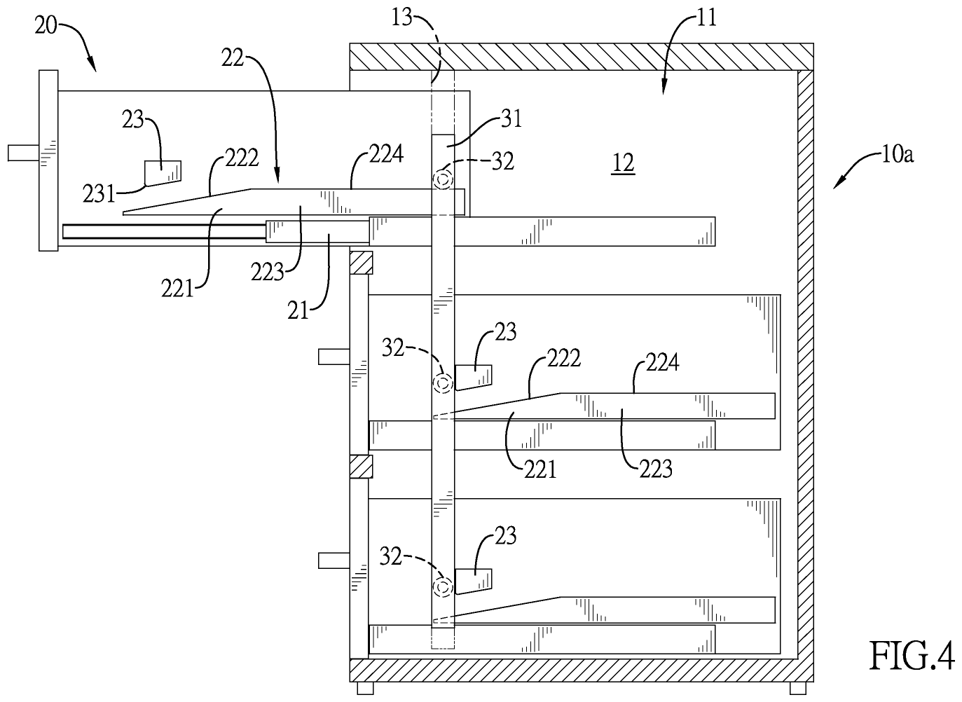

With reference to FIGS. 1 to 4, a first embodiment of an interlocking anti-tipping cabinet in accordance with the present invention comprises a cabinet body 10a, multiple drawers 20 and a linkage mechanism 30a.

With reference to FIGS. 1 to 4, the cabinet body 10a has a loading portion 11, which is formed inside the cabinet body 10a and comprises multiple loading spaces 12 arranged vertically. Each of the multiple loading spaces 12 has an opening oriented forward. The cabinet body 10a has an assembling groove 13, which elongates vertically and is disposed at an inner-side wall of the cabinet body 10a and beside the openings of the multiple loading spaces 12. That is, the assembling groove 13 is relatively near to a front side of the cabinet body 10a and away from a rear side of the cabinet body 10a. The assembling groove 13 communicates with the multiple loading spaces 12.

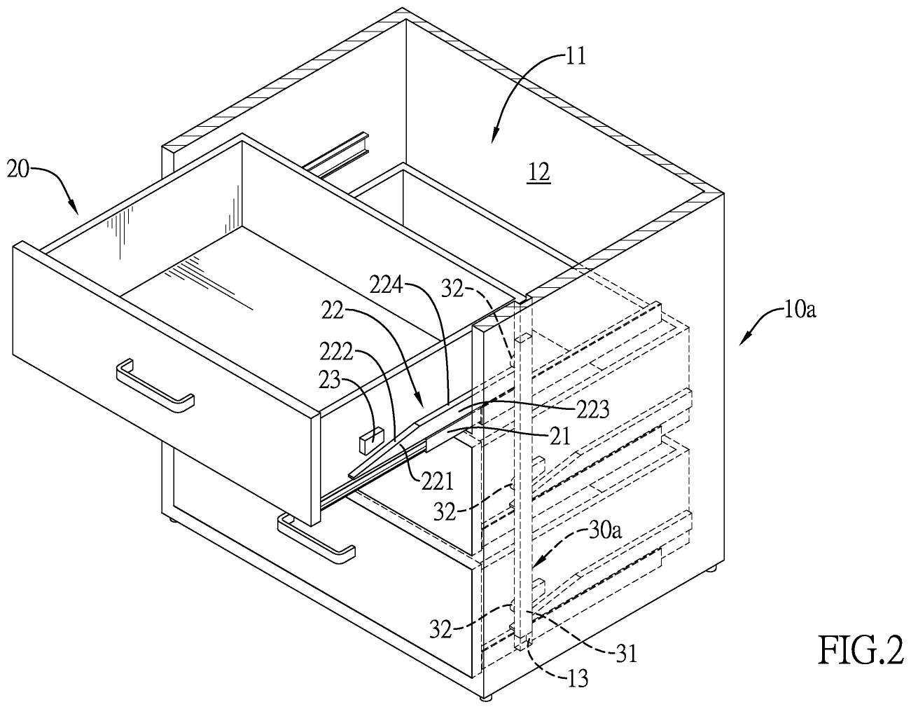

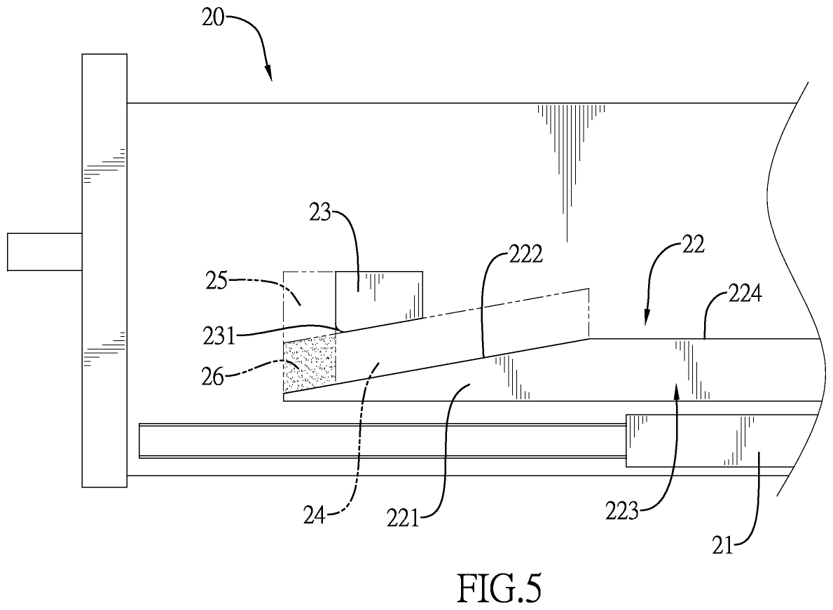

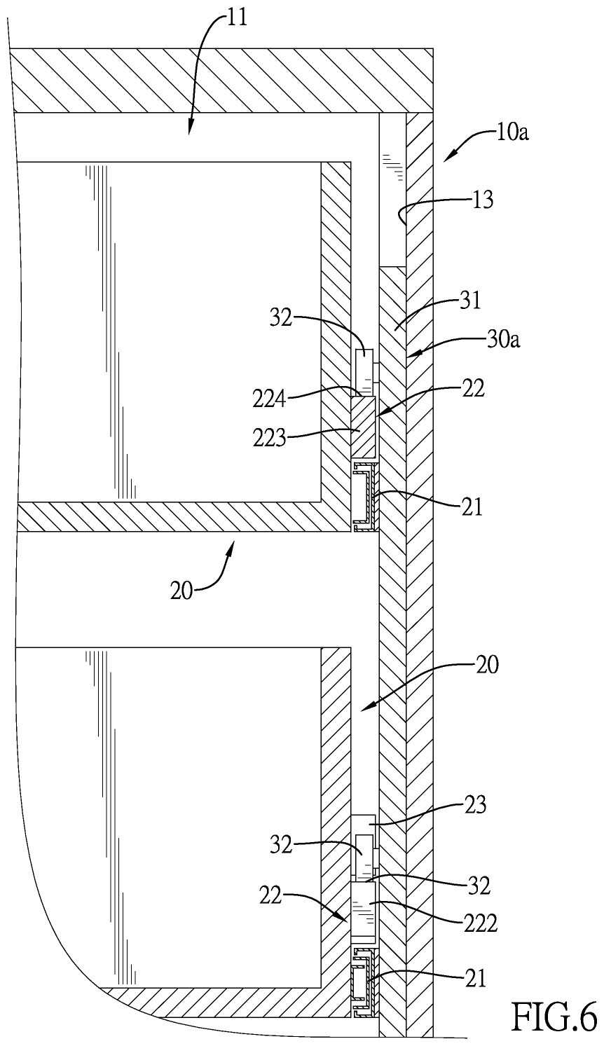

With reference to FIGS. 2 to 7, the multiple drawers 20 are respectively mounted at the multiple loading spaces 12 of the cabinet body 10a. Each one of the multiple drawers has multiple extendable slides 21 elongating horizontally and is mounted at the corresponding loading space 12 of the cabinet body 10a through the multiple extendable slides 21. Each one of the multiple drawers 20 has a side surface, which is oriented toward the assembling groove 13, a guiding rail 22, a blocking chunk 23, an ascending passage 24, a locking passage 25 and an initial area 26. The guiding rail 22 and the blocking chunk 23 both protrude from the side surface. The guiding rail 22 has a wedging section 221, which has a guiding slope 222 having a height increasing backward, and a horizontal section 223, which is connected to a back end of the wedging section 221 and has a positioning plane 224 elongating horizontally. The blocking chunk 23 is disposed over the wedging section 221 of the guiding rail 22. The ascending passage 24 is formed between the wedging section 221 of the guiding rail 22 and the blocking chunk 23. The locking passage 25 is formed on top of the wedging section 221 and at a front side of the blocking chunk 23, and elongates vertically. The initial area 26 is formed at an intersection of the ascending passage 24 and the locking passage 25. In addition, with reference to FIG. 5, the blocking chunk 23 of the multiple drawers 20 has a round corner 231 formed at a front and bottom edge of the blocking chunk 23.

With reference to FIGS. 2 to 7, the linkage mechanism 30a comprises a main shaft 31 and multiple wheels 32. The main shaft 31 is mounted in the assembling groove 13 of the cabinet body 10a and is moveable up and down. The multiple wheels 32 are mounted at a side, oriented toward the multiple drawers 20, of the main shaft 31, and are spaced apart from each other vertically. Each one of the multiple wheels 32 corresponds to one of the multiple drawers 20, is disposed at the initial area 26 of the corresponding drawer 20, and abuts the guiding slope 222 of the wedging section 221 of the guiding rail 22 of the corresponding drawer 20.

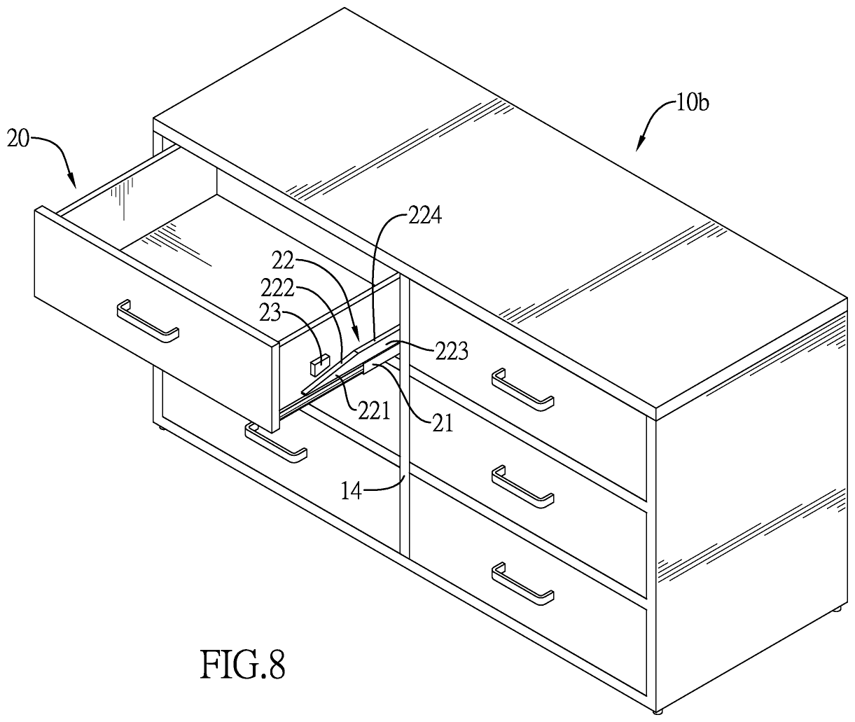

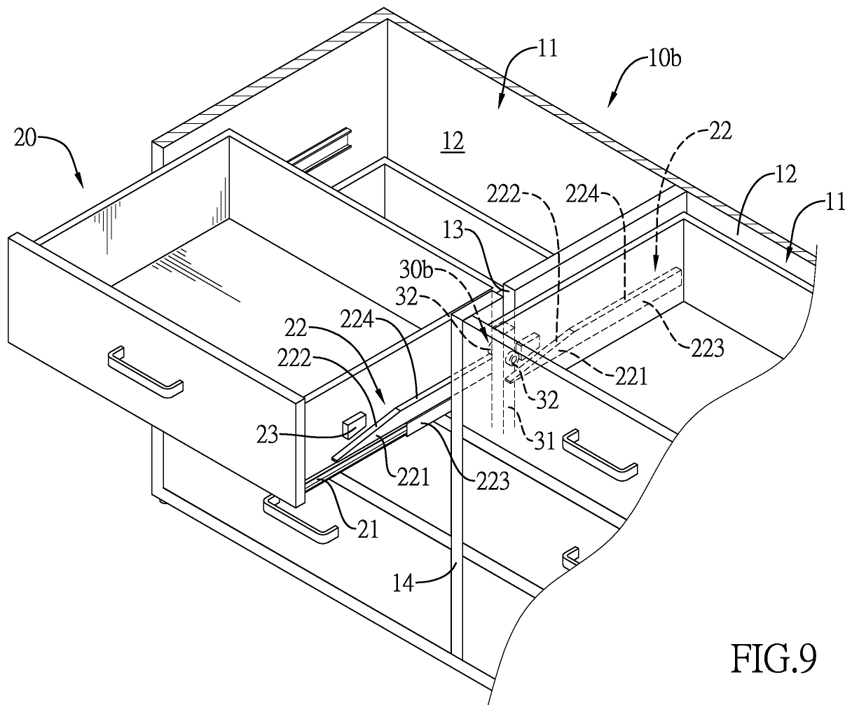

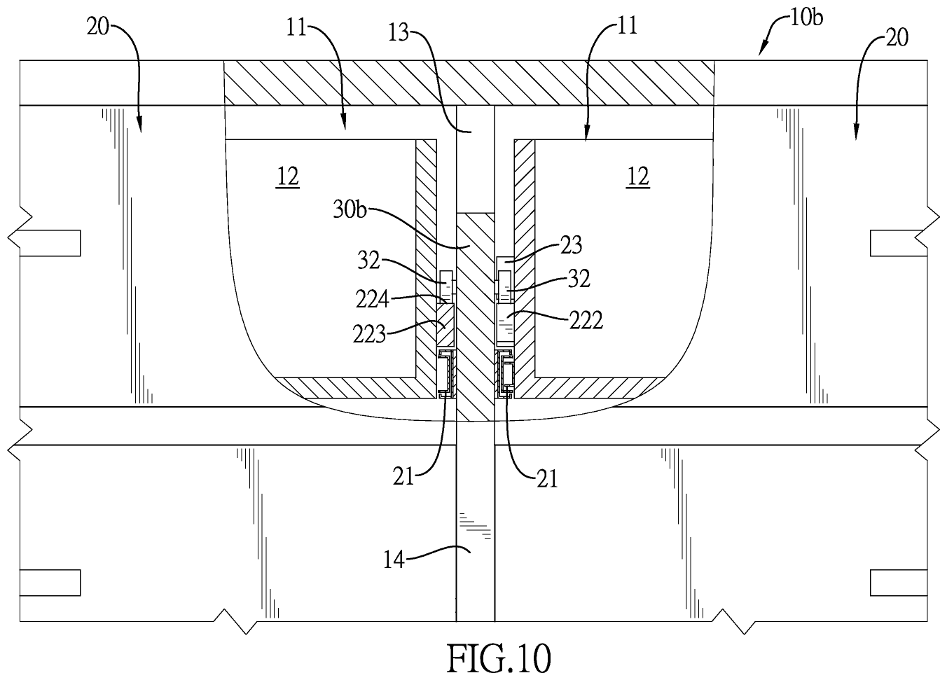

Additionally, with reference to FIGS. 8 to 11, a second embodiment of the interlocking anti-tipping cabinet in accordance with the present invention comprises a cabinet body 10b, multiple drawers 20 and a linkage mechanism 30b.

With reference to FIGS. 8 to 11, the cabinet body 10b has two loading portions 11, which are formed inside the cabinet body 10b. Each of the two loading portions 11 comprises multiple loading spaces 12 arranged vertically. Each of the multiple loading spaces 12 has said opening oriented forward. The cabinet body 10b has an assembling groove 13 and a separating board 14, which is disposed between the two loading portions 11. The assembling groove 13 elongates vertically, is disposed on the separating board 14, and communicates with the multiple loading spaces 12 of the two loading portions 11.

With reference to FIGS. 8 to 11, the multiple drawers 20 are respectively mounted at the multiple loading spaces 12 of the two loading portions 11 of the cabinet body 10b. Each one of the multiple drawers 20 has multiple extendable slides 21 elongating horizontally and is mounted at the corresponding loading space 12 of the cabinet body 10b through the multiple extendable slides 21. Each one of the multiple drawers 20 has a side surface, which is oriented toward the assembling groove 13, a guiding rail 22, a blocking chunk 23, an ascending passage 24, a locking passage 25 and an initial area 26. The guiding rail 22 and the blocking chunk 23 both protrude from and are formed at the side surface. The guiding rail 22 has a wedging section 221, which has a guiding slope 222 having a height progressively increasing backward, and a horizontal section 223, which is connected to a back end of the wedging section 221 and has a positioning plane 224 elongating horizontally. The blocking chunk 23 is disposed over the wedging section 221 of the guiding rail 22. The ascending passage 24 is formed between the wedging section 221 of the guiding rail 22 and the blocking chunk 23. The locking passage 25 is formed on top of the wedging section 221 and at a front side of the blocking chunk 23, and elongates vertically. The initial area 26 is formed at an intersection of the ascending passage 24 and the locking passage 25. In addition, with reference to FIG. 5, the blocking chunk 23 of the multiple drawers 20 has a round corner 231 formed at a front and bottom edge of the blocking chunk 23.

With reference to FIGS. 8 to 11, the linkage mechanism 30b comprises a main shaft 31 and multiple wheels 32. The main shaft 31 is mounted in the assembling groove 13 of the cabinet body 10b and is moveable up and down. The multiple wheels 32 are mounted at two sides, oriented toward the multiple drawers 20, of the main shaft 31, and are spaced apart from each other vertically. Each one of the multiple wheels 32 corresponds to one of the multiple drawers 20, is disposed at the initial area 26 of the corresponding drawer 20, and abuts the guiding slope 222 of the wedging section 221 of the guiding rail 22 of the corresponding drawer 20.

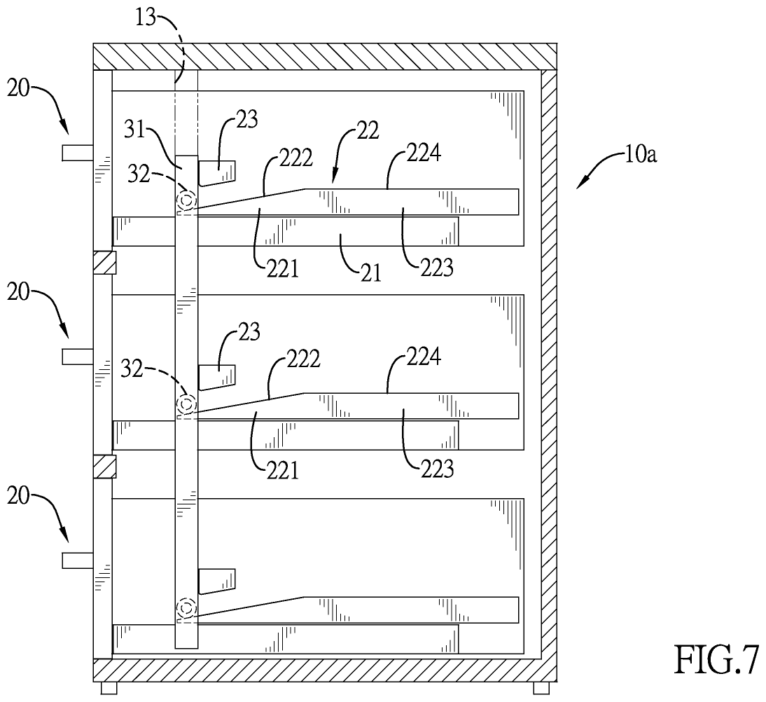

The interlocking anti-tipping cabinet is provided to a user for storing objects by pulling open one of the multiple drawers 20 at a time. As shown in FIG. 7, taking the first embodiment of the interlocking anti-tipping cabinet as an example, when all of the multiple drawers 20 are closed and put back inside the cabinet body 10a, the multiple wheels 32 of the linkage mechanism 30a are respectively disposed at the initial areas 26 of the multiple drawers 20.

With reference to FIGS. 1 to 6, when the user pulls out one of the multiple drawers 20, the wheel 32 corresponding to said drawer 20 is guided by the guiding slope 222 of the wedging section 221 of the guiding rail 22 of said drawer 20 and is moved upward along the ascending passage 24 to the positioning plane 224 of the horizontal section 223. Simultaneously, the linkage mechanism 30a is driven by said wheel 32 and moved upward along the assembling groove 13. So, the wheels 32, corresponding to the rest of the drawers 20, are respectively moved away from the initial areas 26 along the locking passages 25 to the front sides of the corresponding blocking chunks 23. At this time, the blocking chunks 23 of the rest of the drawers 20 are blocked by the corresponding wheels 32 and are limited in position. So, the rest of the drawers 20 are locked, thereby efficiently avoiding cabinet tip-over, which is due to the multiple pulled-open drawers 20 shifting the cabinet's gravity center.

With reference to FIGS. 1 to 7, when the user pushes the pulled-out drawer 20 back into the loading space 12, the wheel 32 corresponding to said drawer is moved from the horizontal section 223 to the ascending passage 24 along with the movement of the guiding rail 22 of said drawer 20. Said wheel 32 then is moved downward and along the wedging section 221 of the guiding rail 22, and eventually enters the initial area 26. At the same time, the linkage mechanism 30a is driven by said wheel 32 and is moved downward along the assembling groove 13, and the wheels 32 corresponding to other drawers 20 are moved back from the front sides of the corresponding blocking chunks 23 to the initial areas 26 along the locking passages 25, thereby unlocking said other drawers 20.

In addition, with reference to FIGS. 8 to 11, in the second embodiment of the interlocking anti-tipping cabinet, the linkage mechanism 30b cooperates with the arrangement of the multiple drawers 20 and thus is structurally symmetrical. When pulling out any of the multiple drawers 20, the linkage mechanism 30b locks other drawers 20 simultaneously as mentioned above.

Additionally, the round corner 231 at the front and bottom edge of the blocking chunk 23 reduces friction and resistance when the wheel 32 passes through the blocking chunk 23, thereby increasing smoothness when the user moves the drawer 20.

To sum up, by structural designs of the guiding rail 22 and the blocking chunk 23 of each of the multiple drawers 20 and the linkage mechanism 30a, 30b, the interlocking anti-tipping cabinet possesses the function of locking the rest of the drawers 20 when one drawer 20 is pulled open. At the same time, an overall structure of the cabinet is simplified, hence effectively decreasing the assembling difficulty and costs of materials and processing.

Even though numerous characteristics and advantages of the present invention have been set forth in the foregoing description, together with details of the structure and features of the invention, the disclosure is illustrative only. Changes May be made in the details, especially in matters of shape, size, and arrangement of parts within the principles of the invention to the full extent indicated by the broad general meaning of the terms in which the appended claims are expressed.

What is claimed is:

1. An interlocking anti-tipping cabinet comprising:
a cabinet body having
a loading portion formed inside the cabinet body and comprising
multiple loading spaces arranged vertically; each of the multiple loading spaces having
an opening oriented forward;
an assembling groove elongating vertically, disposed at an inner-side wall of the cabinet body and beside the openings of the multiple loading spaces, and communicating with the multiple loading spaces;
multiple drawers respectively mounted at the multiple loading spaces of the cabinet body; each one of the multiple drawers having
multiple extendable slides elongating horizontally; the drawer mounted at the corresponding loading space of the cabinet body through the multiple extendable slides;
a side surface oriented toward the assembling groove;
a guiding rail protruding from the side surface, and having
a wedging section having
a guiding slope having a height progressively increasing backward;
a horizontal section connected to a back end of the wedging section and having
a positioning plane elongating horizontally;
a blocking chunk protruding from the side surface, and disposed over the wedging section of the guiding rail;
an ascending passage formed between the wedging section of the guiding rail and the blocking chunk;
a locking passage formed on top of the wedging section and at a front side of the blocking chunk, and elongating vertically;
an initial area formed at an intersection of the ascending passage and the locking passage;
a linkage mechanism comprising
a main shaft mounted in the assembling groove of the cabinet body and being moveable up and down; and
multiple wheels mounted at a side, oriented toward the multiple drawers, of the main shaft, and spaced apart from each other; each one of the multiple wheels corresponding to one of the multiple drawers, disposed at the initial area of the corresponding drawer, and abutting the guiding slope of the wedging section of the guiding rail of the corresponding drawer.

2. The interlocking anti-tipping cabinet as claimed in claim 1, wherein
the blocking chunk of each of the multiple drawers has
a round corner formed at a front and bottom edge of the blocking chunk.

3. An interlocking anti-tipping cabinet comprising:
a cabinet body having
two loading portions formed inside the cabinet body, and each one of the two loading portions comprising
multiple loading spaces arranged vertically; each of the multiple loading spaces having
an opening oriented forward;
a separating board disposed between the two loading portions;
an assembling groove elongating vertically, disposed on the separating board, and communicating with the multiple loading spaces of the two loading portions;
multiple drawers respectively mounted at the multiple loading spaces of the two loading portions of the cabinet body; each one of the multiple drawers having
multiple extendable slides elongating horizontally; the drawer mounted at the corresponding loading space of the cabinet body through the multiple extendable slides;
a side surface oriented toward the assembling groove;
a guiding rail protruding from the side surface, and having
a wedging section having
a guiding slope having a height progressively increasing backward;
a horizontal section connected to a back end of the wedging section and having
a positioning plane elongating horizontally;
a blocking chunk protruding from the side surface, and disposed over the wedging section of the guiding rail;
an ascending passage formed between the wedging section of the guiding rail and the blocking chunk;
a locking passage formed on top of the wedging section and at a front side of the blocking chunk, and elongating vertically;
an initial area formed at an intersection of the ascending passage and the locking passage;
a linkage mechanism comprising
a main shaft mounted in the assembling groove of the cabinet body and being moveable up and down; and
multiple wheels mounted at two sides, oriented toward the multiple drawers, of the main shaft, and spaced apart from each other; each one of the multiple wheels corresponding to one of the multiple drawers, disposed at the initial area of the corresponding drawer, and abutting the guiding slope of the wedging section of the guiding rail of the corresponding drawer.

4. The interlocking anti-tipping cabinet as claimed in claim 3, wherein
the blocking chunk of each of the multiple drawers has
a round corner formed at a front and bottom edge of the blocking chunk.
